(19) United States
(12) Patent Application Publication
(10) Pub. No.: US 2009/0057294 A1
(43) Pub. Date: Mar. 5, 2009

(54) ASSEMBLY POT WITH A HEAT PLATE AND THE HEAT PLATE

(75) Inventor: Ching-Horng CHANG, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Ching-Horng CHANG, Taipei City (TW)

(21) Appl. No.: 12/198,994

(22) Filed: Aug. 27, 2008

(30) Foreign Application Priority Data
Aug. 27, 2007 (TW) 096131734

(51) Int. Cl. H05B 3/68

(52) U.S. Cl. 219/443.1

(57) ABSTRACT

This invention discloses an assembly pot with a heat plate and its heat plate, wherein the heat plate comprises a base and a plate body. The plate body has an opening thereon, and the plate body's circumferential edge is sealed on a side of the base to define a containing space between the plate body and the base. The containing space can be filled with some liquid via the opening and the plate body can be retained the heat by boiling the liquid. Therefore, when the plate body stays at a high temperature, the food on the plate body will be heated evenly.

### RELATED APPLICATIONS

This application claims priority to Taiwan Application Serial Number 096131734, filed Aug. 27, 2007, which is herein incorporated by reference.

### BACKGROUND

1. Field of Invention

This invention is related to a heat plate, and more particularly to heat plate on an assembly pot.

2. Description of Related Art

New and improved commercial products have been developed in recent years that provide convenience and effectiveness to consumers who are becoming more demanding. When developing new products, designers have to be increasingly aware of the safety issues as well as the aesthetic appeal of the product. Consumers have become more safety conscious and demand good-looking products that can enhance their lives. A sectional view of a traditional Korean BBQ grill plate is shown in FIG. 1. The grill plate 500 in FIG. 1 is commonly used in Korean barbecue restaurants. The grill plate 500 is made of a material that is typically an excellent heat conductor. The grill plate 500 also has a bulge 501 on one side thereof. The opposite side of the bulge, 502, is a depression. The grill plate 500 can be placed on a stove with the depression 502 facing the stove. When the stove heats the grill plate 500, the heat from the stove is gradually conducted towards the top point of the bulge 501. When cooking food on the grill plate, users will place the food on the bulge 501 and allow the heat transferred from the stove to the grill plate 500 to cook the food.

Note however that the vertical distance between each point of the bulge 501 and the stove are not equal. This means heat from the stove is not distributed uniformly throughout the grill plate 500. That is, the temperature of the grill plate 500 at the top of the bulge 501 is different from the temperature at other locations of the grill plate 500. This means that the food cooks at different speeds and if the user is not aware of the temperature differentials between different locations of the grill plate 500, the food being cooked may either be charred (overcooked) or raw (undercooked). This may frustrate users and they may lose interest during the BBQ activity and prevent them from returning to the restaurant in the future. Furthermore, charred or raw food may have a bad effect on the consumers' health. Thus, the related industries need to overcome the drawbacks of the forgoing grill plate.

### SUMMARY

It is therefore an objective of the present invention to present an assembly pot with a heat plate whereby the temperature of heat plate at all locations is uniform enabling the food to be evenly cooked on the heat plate.

To achieve the foregoing objectives, the present invention provides a heat plate comprising a base and a plate body. The plate body has an opening thereon, and has a circumferential edge sealed on a side of the base to form a containing space between the plate body and the base. The containing space can be filled with liquid through the opening and the plate body can be kept hot by boiling the liquid. Therefore, when the plate body stays at a high temperature, the food on the plate body will be heated evenly.

According to a preferred embodiment, a lid, an air vent and a heat conductive layer are further disposed thereon. The lid is disposed such that it can be moved or rotated on the plate body adjacent to the opening and being rotated to cover or expose the opening. An air vent is formed on the lid. The air vent allows steam to be released from the containing space when the liquid boils. Releasing the steam through the air vent reduces the pressure inside the containing space. The heat conductive layer made by electrically conductive metal is disposed on a surface of the base opposite to the plate body, so that the heat conductive layer provides a uniform distribution of heat to the plate body when the heat plate is placed on an apparatus that converts electricity into heat.

The invention also provides an assembly pot with the foregoing heat plate. The assembly pot comprises a pot body and a plate body. The plate body has an opening thereon and the plate body has a circumferential edge sealed on a side of an inner surface of the pot body to form a containing space between the plate body and the pot body. The containing space can be filled with some liquid via the opening and the plate body can be kept hot by boiling the liquid. Therefore, when the plate body stays at a high uniform temperature, food on the plate body will be heated evenly.

The key element of the featured technique of the present invention is a plate body with a uniform distribution of heat everywhere that provides food being cooked with an even heat distribution on the plate when the liquid is heated and boils in the containing space.

### BRIEF DESCRIPTION OF THE DRAWINGS

The structure and the technical means adopted by the present invention to achieve the above and other objectives can be best understood by referring to the following detailed description of the preferred embodiments and the accompanying drawings, where:

FIG. 1 is a sectional view of a traditional Korean BBQ grill plate;

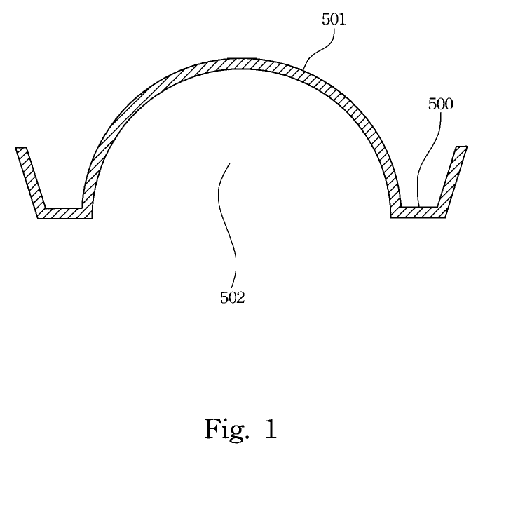

FIG. 2 is a three dimensional view of an assembly pot with a heat plate according to he present invention;

FIG. 3 is a sectional view and schematic view in operating the heat plate of the present invention.

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

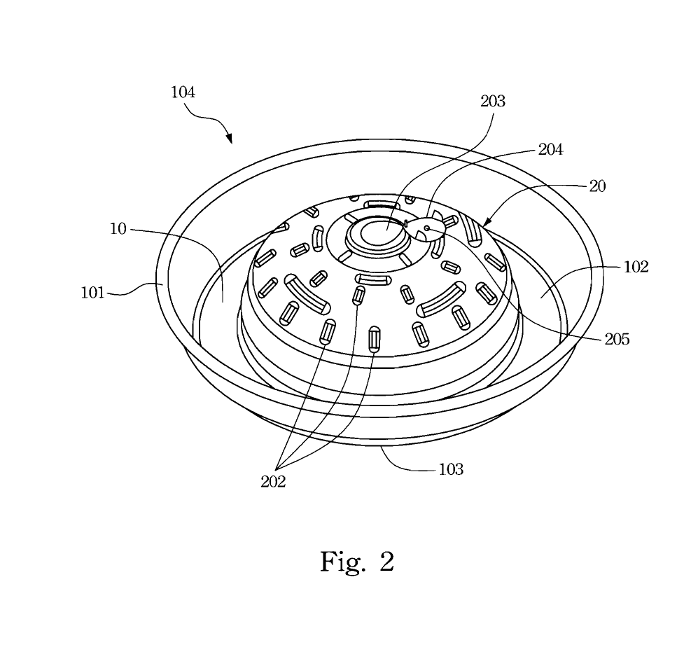

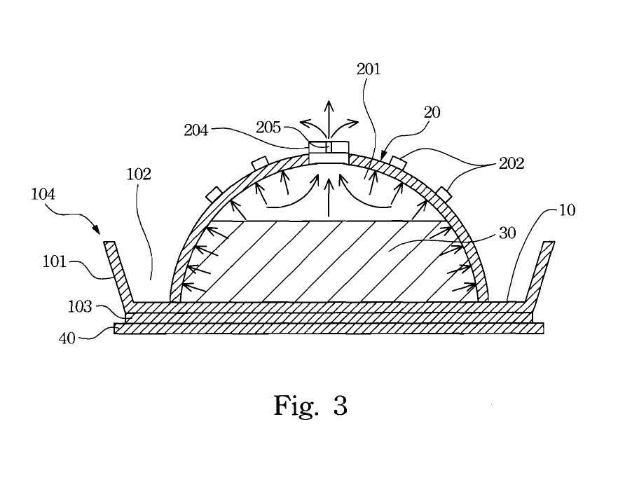

Refer to FIG. 2 and FIG. 3. FIG. 2 is a three dimensional view of an assembly pot with a heat plate. FIG. 3 is a sectional and schematic view of heat plate of the present invention when in operation. The present invention provides an assembly pot with a heat plate and the heat plate. In a preferred embodiment, the assembly pot has a heat plate and a pot body. The heat plate comprises a highly heat- conductive circular base 10 and a plate body 20 with a hemisphere profile. The plate body 20 has a containing space 201 enclosed by its circumferential edge, and an opening 203 on the plate body 20 connecting to the containing space 201. The plate body 20 is sealed on a side of the base 10 by its circumferential edge to seal the containing space 201 between the plate body 20 and the base 10. The containing space 201 can be filled with a quantity of liquid 30 (e.g. water, water containing salt or oil) via the opening 203.

A lid 204 is movably or specifically pivotally disposed on the plate body 20 adjacent to the opening 203. The lid 204 can be rotated to cover the opening 203 to prevent liquid 30 from leaking out of the containing space 201, or the lid 204 can be rotated to expose the opening 203 for filling up some liquid 30.

The lid 204 has an air vent 205 on the lid 204. When the lid 204 covers the opening 203 and the liquid 30 therein boils to generate steam, the air vent 205 provides an exit to release the steam and relieve the pressure inside the containing space 201.

Additionally, a plurality of protrusions 202 are arranged on the curved surface of the hemispheric plate body 20. These protrusions 202 prevent the food from slipping down the plate body 20.

The pot body 104 for the embodiment is formed by extending a flange 101 around a circumferential edge of the base 10 and a ring groove 102 is formed between the plate body 20 and the flange 101. The ring groove 102 collects wasted oil, juice or dregs that come from the food (especially the meat) being grilled. The ring groove 102 can be deeper than that to provide customer to fill with hot pot soups and food.

Also a heat-conductive layer 103, made by electrically conductive metal (e.g. stainless steel, chromium and iron), is disposed on a surface of the pot body 104 or the base 10 opposite to the plate body 20, so that the heat conductive layer 103 provides a uniform distribution of heat to the plate body 20 when the pot body 104 or the base 10 is placed on an apparatus that converts electricity into heat (e.g. electric magnetic cooker) with the heat-conductive layer 103.

Therefore, when the pot body 104 or the base 10 is placed on an electric magnetic cooker and is heated by the electric magnetic cooker, the liquid 30 in the containing space 201 is gradually heated to boiling point. In this case the liquid 30 is water. When the water is heated to boiling point, the curved surface of the plate body 20 reaches a temperature of around 100 degree centigrade. Thus, the plate body 20 can be kept at a constant temperature by continually boiling water. Therefore, when the plate body 20 stays in a constantly high temperature, food on the plate body 20 will be heated evenly.

Note that when the liquid 30 boils, the temperature on the plate body may vary within a range of three degrees centigrade to five degrees centigrade. These temperature variations are caused by unpredictable, localized circumstances at the time and place the barbecue plate is used. These circumstances include the local air temperature and atmospheric pressure. Therefore, the temperature on the plate will not always be exactly uniform.

Although the present invention has been described in considerable detail with reference in the certain preferred embodiments thereof, other embodiments do not only limit the shapes of the plate body 20, the base 10 and the pot body 104 to the very shapes mentioned above. Therefore, the spirit and scope of the appended claims should not be limited to the description of the preferred embodiments contained herein.

What is claimed is:

1. A heat plate, comprising:
a base; and
a plate body having an opening thereon, a circumferential edge thereof sealed on the base, and a containing space formed between the plate body and the base;
wherein the containing space is capable of being filled with liquid via the opening, and the plate body is capable of retaining the heat by boiling the liquid.

2. The heat plate as claimed in claim 1, wherein a lid is movably disposed over the opening.

3. The heat plate as claimed in claim 2, wherein the lid is pivotally disposed on the plate body adjacent to the opening and is rotated to cover or expose the opening.

4. The heat plate as claimed in claim 3, wherein an air vent is formed on the lid.

5. The heat plate as claimed in claim 1, wherein the plate body has a hemisphere profile.

6. The heat plate as claimed in claim 1, wherein a heat conductive layer made by electrically conductive metal is disposed on a surface of the base opposite to the plate body.

7. The heat plate as claimed in claim 1, wherein the liquid is a quantity of water.

8. The heat plate as claimed in claim 7, wherein the water contains salt.

9. The heat plate as claimed in claim 1, wherein the liquid is a quantity of oil.

10. An assembly pot with a heat plate, comprising:
a pot body; and
a plate body having an opening disposed thereon, a circumferential edge thereof sealed on an inner surface of the pot body, and a containing space formed between the plate body and the pot boy;
wherein the containing space is capable of being filled with liquid via the opening, and the plate body is capable of retaining the heat by boiling the liquid.

11. The assembly pot with a heat plate as claimed in claim 10, wherein a lid is movably disposed over the opening.

12. The assembly pot with a heat plate as claimed in claim 10, wherein, wherein the lid is pivotally disposed on the plate body adjacent to the opening and being rotated to cover or expose the opening.

13. The assembly pot with a heat plate as claimed in claim 12, wherein an air vent is formed on the lid.

14. The assembly pot with a heat plate as claimed in claim 10, wherein a heat conductive layer made by electrically conductive metal is disposed on a surface of the base opposite to the plate body.

15. The assembly pot with a heat plate as claimed in claim 10, wherein the liquid is a quantity of water.

16. The assembly pot with a heat plate as claimed in claim 15, wherein the water contains salt.

17. The assembly pot with a heat plate as claimed in claim 10, wherein the liquid is a quantity of oil.
